(19) United States
(12) Patent Application Publication
(10) Pub. No.: US 2025/0199929 A1
(43) Pub. Date: Jun. 19, 2025

(54) ON-DEVICE JOURNEY EXECUTION

(71) Applicant: ADOBE INC., SAN JOSE, CA (US)

(72) Inventors: Shiladitya BOSE, Nodia (IN); Saurabh GARG, New Delhi (IN); Mukul LAMBA, Shimla (IN); Mandeep SINGH, Bhiwadi (IN); Kaushal MISHRA, Bangalore (IN)

(21) Appl. No.: 18/545,832

(22) Filed: Dec. 19, 2023

(51) Int. Cl. G06F 11/30; G06F 11/34

(52) U.S. Cl. CPC G06F 11/3072; G06F 11/3438

(57) ABSTRACT

Methods and systems are provided for on-device journey execution. In embodiments described herein, a selection to publish a journey on a device is received. A representation of the journey is communicated from a server to the device over a network to store the journey locally on the device. At least a portion of the journey is executed on the device using the journey stored locally on the device.

### BACKGROUND

A customer journey refers to a series of interactions a customer has with a company across various channels over time. Businesses or marketers can design customer journeys to create targeted, personalized advertising campaigns for customers based on specific interactions with the customer, thereby improving customer engagement and conversion rates. However, oftentimes, customers will initiate events or conditions of the journey while the customer's device is disconnected from communication with a server that executes actions associated with the journey. For example, the user may be on an airplane or interact with a mobile application while the phone is not connected to the internet. In this regard, actions will not be executed with respect to the journey until the device communicates with the server that executes actions associated with the journey, such as when the mobile device reconnects to the internet.

### SUMMARY

Various aspects of the technology described herein are generally directed to systems, methods, and computer storage media for, among other things, on-device journey execution. In this regard, embodiments described herein facilitate the execution of an action of a customer journey based on local (e.g., in-app) events or conditions of the device without having to communicate the events or conditions over a network. For example, a journey corresponding to interactions between a customer and an application can be stored directly on a customer device. A customer triggers an event or condition of the journey through interactions with the application on the device. Responsive to triggering the event or condition, an action of the journey corresponding to an action of the application is then executed directly on the device without communicating the event or condition to a journey management platform over a network.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 depicts a diagram of an environment in which one or more embodiments of the present disclosure can be practiced, in accordance with various embodiments of the present disclosure.

FIG. 2 depicts an example configuration of an operating environment in which some implementations of the present disclosure can be employed, in accordance with various embodiments of the present disclosure.

FIG. 3 provides an example diagram of an architecture for implementing on-device journey execution, in accordance with embodiments of the present disclosure.

FIGS. 4 and 5 provide example diagrams of a user interface with an example journey for implementing on-device journey execution, in accordance with embodiments of the present disclosure.

FIG. 6 is a process flow showing a method for implementing on-device journey execution, in accordance with embodiments of the present disclosure.

FIG. 7 is a process flow showing a method for implementing on-device journey execution, in accordance with embodiments of the present disclosure.

FIG. 8 is a process flow showing a method for implementing on-device journey execution, in accordance with embodiments of the present disclosure.

FIG. 9 is a block diagram of an example computing device in which embodiments of the present disclosure can be employed.

### DETAILED DESCRIPTION

Various terms are used throughout the description of embodiments provided herein. A brief overview of such terms and phrases is provided here for ease of understanding, but more details of these terms and phrases is provided throughout.

A “journey” or “customer journey” refers to a pre-determined path designed by a business in which automated actions are executed in response to a series or sequence of potential interactions with a customer over time. Journeys occur over various channels, such as e-mail, phone calls/texting, social media, websites, physical locations, and any channel in which a customer and business interact. A journey can include a set of one or more events, conditions, and/or corresponding actions. To this end, a journey can include a sequence of events, conditions, and/or actions through which customers may traverse. Journeys can be designed by users, such as marketers or businesses, to meet the goals of the business, such as to obtain new customers, develop leads, increase conversions, and increase loyalty. Journeys can be designed with various paths based on customer interactions, behavior, preferences, customer demographics, etc.

An “event” refers to an interaction of a customer with a business or that a business performs on behalf of a customer. Examples of events include selecting or clicking on a particular product, purchasing a particular product, navigating to a particular website, opening an e-mail, clicking a link, contacting customer service, entering and/or existing a retail brick-and-mortar store, and the like. Events can be used in journeys to trigger certain actions by the business, such as automated messaging. An event can be represented as a JavaScript Object Notation (“JSON”) with nested fields corresponding to data regarding each event. The events can include fields, such as time of the interaction, price of the product, location data for the customer (e.g., latitude and longitude, IP address, physical store address, etc.), website address for the web page visited by the customer, product type, or any data that a business/marketer includes in an event of a journey. Further, in some embodiments, the events can include fields related to customer demographic information and can include the customer's geographical location, economic status, customer gender, customer age, or any other relevant demographic data collected regarding the customer.

A “condition” refers to a rule or set of rules that are evaluated based on certain events and/or customer data and are used to determine next interactions in a journey. Examples of conditions can include customer demographics, customer behavior, time elapsed, etc. For example, a customer may abandon an online cart and a business may set a condition to send a communication regarding the abandoned cart after a period of time.

An “action” refers to a specific response triggered by an event or conditions within a journey. Actions are used to automate personalized customer journeys by taking specific steps for specific customers when customers perform certain interactions (e.g., an event occurs) or certain conditions are met for the customer. Examples of actions include sending a push notification, displaying one or more recommended products, sending an e-mail, displaying a message on a website, updating a customer record/profile, or any action that a business takes with respect to its customer or potential customer. Following an action, an event can occur when the customer interacts with action generated by the business.

A “software development kit (“SDK”)” refers to a set of software tools that developers use to create applications for specific software platforms and integration with various application programming interfaces (“APIs”) and services.

A “state machine” is a computational model that can be in one of a finite number of states at a given time. The state machine transitions from one state to another in response to input, such as an event, condition or action of a journey. When a state machine persists, the state machine stores the current state of the state machine. After the current state is stored, the state machine can resume operation to determine whether to transition to a different state.

“Customer data” refers to any data regarding a customer or customers. Customer data within a dataset may include, by way of example and not limitation, data that is sensed or determined from one or more sensors, such as location information of mobile device(s), smartphone data (such as phone state, charging data, date/time, or other information derived from a smartphone), activity information (for example: app usage; online activity; searches; browsing certain types of webpages; listening to music; taking pictures; voice data such as automatic speech recognition; activity logs; communications data including calls, texts, instant messages, and emails; website posts; other user data associated with communication events) including activity that occurs over more than one device, user history, session logs, application data, contacts data, calendar and schedule data, notification data, social network data, news (including popular or trending items on search engines or social networks), online gaming data, ecommerce activity, including customer journey data, sports data, health data, customer demographics, customer's geographical location, economic status, customer gender, customer age, or any other relevant demographic data collected regarding the customer, and nearly any other source of data that may be used to identify the customer.

“Serverless computing services” refer to a serverless architecture that allows developers to build and deploy applications without managing the underlying infrastructure. For example, developers can deploy serverless functions that respond to occurrences or triggers, such as a hypertext transfer protocol (HTTP) request, a change in a database, an upload of a file, and/or the like. In this regard, a set of APIs and/or SDKs that access the serverless computing services can be provided to developers that allow developers to implement various tools and/or services into an application. In some embodiments, serverless computing services can automatically scale based on demand.

### Overview

A customer journey refers to a series of interactions a customer has with a company across various channels over time. For example, these interactions (e.g., events) can include website/mobile application visits, clicking an advertisement, social media interactions, email communications, such as opening an e-mail, visiting a physical store or location, adding an item to an online cart, abandoning a cart, downloading a product for a free trial, checking out and purchasing the item, requesting help, or any interaction a customer initiates with a business. Business or marketers can design customer journeys to create targeted, personalized advertising campaigns for customers based on specific interactions with the customer, thereby improving customer engagement and conversion rates. The customer journey designed by the business/marketer can include interactions with the customer (e.g., actions or responses) in response to interactions by the customer (e.g., events). For example these interactions (e.g., actions or responses) by the business can include personalizing the customer's experience based on the customer's data, targeting advertisements, sending email communications to the customer, sending follow-up email communications to the customer, initiating a phone call with the customer, sending confirmation email of a product purchase, requesting a product review, cross-selling other products, sending a communication regarding an abandoned cart with or without discounts, or any other interaction a business/marketer desires in response to a customer's interaction with the business.

The interactions between the business and a customer during a customer journey creates a distinctive customer experience. A distinctive customer experience increases the likelihood that customer will repeat a purchase with a business, spend more with the business, recommend the business or product to others, and maintain loyalty to the business. However, oftentimes, customers will initiate events or conditions of the journey while the customer's device is disconnected from communication with a server that executes actions associated with the journey. For example, the user may be on an airplane or interact with a mobile application while the phone is not connected to the internet. In this regard, actions will not be executed with respect to the journey until the device communicates with the server that executes actions associated with the journey, such as when the mobile device reconnects to the internet.

Currently, there is an absence of a tool to facilitate the execution of an action of a customer journey based on local (e.g., in-app) events or conditions of the device without having to communicate the events or conditions over a network. In this regard, when a device meets certain conditions or events related to a journey, but the device is not connected to the internet, the actions associated with the conditions or events will not be executed in real-time as the journey will not be executed until the device is reconnected to the network. Further, data must be communicated over a network in order to facilitate execution of the journey, rather than executing the journey locally (e.g., on-device) and/or offline based on the data of the device.

Accordingly, unnecessary computing resources are utilized to implement customer journeys in conventional implementations. For example, computing and network resources are unnecessarily consumed in an effort to facilitate the execution of a journey when the device is not connected to the internet by requiring communication of the journey over a network in order to execute the journey and requiring continuous attempts to communicate the data related to the journey while the device is not connected to the network (e.g., until the device reconnects to the network). For instance, computer input/output operations are unnecessarily increased in order to continuously attempt to communicate the data related to the journey while the device is not connected to the network. Further, computing resources are unnecessarily used to continuously attempt to communicate the data related to the journey while the device is not connected to the network, which is computationally expensive. Further, the requirement that data must be communicated over a network in order to facilitate execution of the journey, rather than executing the journey locally (e.g., on-device) and/or offline based on the data of the device, decreases the throughput for the network, increases the network latency, and increases packet generation costs as the journey must be implemented over the network instead of locally (e.g., on-device) and/or offline on the device. Even further, the requirement that data must be communicated over a network in order to facilitate execution of the journey, rather than executing the journey locally (e.g., on-device) and/or offline based on the data of the device, decreases the speed at which the journey can be executed as the data must be communicated back and forth over the network.

As such, embodiments of the present disclosure are directed to on-device journey execution in an efficient and effective manner. In this regard, embodiments described herein facilitate the execution of an action of a customer journey based on local (e.g., in-app) events or conditions of the device without having to communicate the events or conditions over a network. For example, a journey corresponding to interactions between a customer and an application can be stored directly on a customer device. A customer triggers an event or condition of the journey through interactions with the application on the device. Responsive to triggering the event or condition, an action of the journey corresponding to an action of the application is then executed directly on the device without communicating the event or condition to a journey management platform over a network.

In operation, as described herein, a journey is designed by a journey designer, such as a user implementing customer journeys on behalf of a business, through a journey management platform. The journey can be designed through the journey management platform to utilize in-application (“in-app”) interactions between a customer (e.g., a user utilizing an application of a business, such as a mobile application of the business) and an application executing on the customer's device. For example, the application may enable a push notification (e.g., an action of a journey) responsive to a customer adding an item to a cart and subsequently closing the application (e.g., events of the journey). In this regard, the journey can be published to the customer's device, thereby storing the journey directly on the customer's device. By storing the journey directly on the customer's device, the journey can be executed directly on the customer's device based on the in-app interactions between the customer and the application without requiring communication of the various states of the journey over a network to a server implementing the journeys.

In some embodiments, a software development kit (“SDK”) for on-device journey orchestration is stored on a customer's device in communication with and/or as a part of the application. The SDK can include various tools to communicate with a journey management platform to receive journeys related to the application or communicate the state of the journeys stored on the device, listen to in-app interactions between the customer and the application on the device, and execute journeys on the device. In this regard, the SDK for on-device journey orchestrations enables the execution of journeys on the device of a customer after the journey is stored on the device without having to communicate each state of the journey (e.g., the change to the journey as each event, condition, and/or action of the journey occurs) to the journey management platform before proceeding to the next step of the journey. When the device is connected to the network and/or at certain intervals, the SDK can communicate the state of the journey or other customer data to the journey management platform and/or receive new journeys or updates to journeys for storage on the customer's device.

In some embodiments, the journey management platform includes a remote device handler service that utilizes customer data to only implement the journey's on the device of a customer that pertain to that specific customer. For example, if a journey is directed to a customer that purchased a specific product based on the purchase history in the customer data for the customer, remote devices handler service can determine whether the customer associated with customer device meets the requirements of the journey (e.g., whether the customer data indicates that the customer purchased the specific product). If the customer meets the requirements of the journey, remote devices handler service can store the journey on the customer's device. In this regard, computing and network resources can be conserved in that only data for journeys related to the specific customer of the customer device are communicated and/or stored on the customer's device.

Advantageously, efficiencies of computing and network resources can be enhanced using implementations described herein. In particular, the execution of a customer journey on-device and based on local (e.g., in-app) events or conditions of the device without having to communicate the events or conditions over a network provides for a more efficient use of computing resources (e.g., less computationally expensive, less input/output operations, higher throughput and reduced latency for a network, less packet generation costs, etc.) than conventional methods that require the communication of the journey over a network and continuous attempts to communicate the data related to the journey over the network while the device is not connected to the network (e.g., until the device reconnects to the network). In this regard, the technology described herein enables efficient and effective on-device journey execution, thereby reducing unnecessary computing resources used to continuously attempt to communicate the data related to the journey while the device is not connected to the network. The technology described herein conserves network resources as the technology results in on-device journey execution instead of requiring data related to the journey to be communicated over a computer network in order to facilitate execution of the journey, which results in higher throughput, reduced latency and less packet generation costs as fewer packets are sent over the network. Even further, the technology described herein facilitates real-time execution of journeys.

### Overview of Exemplary Environments of On-Device Journey Execution

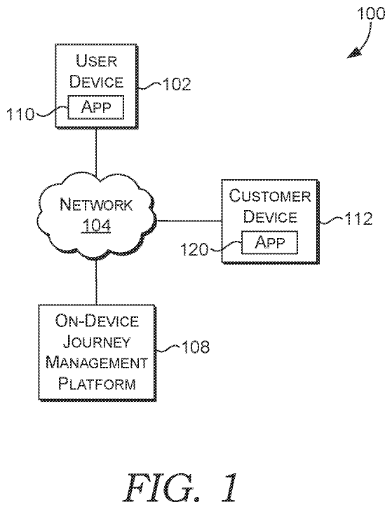

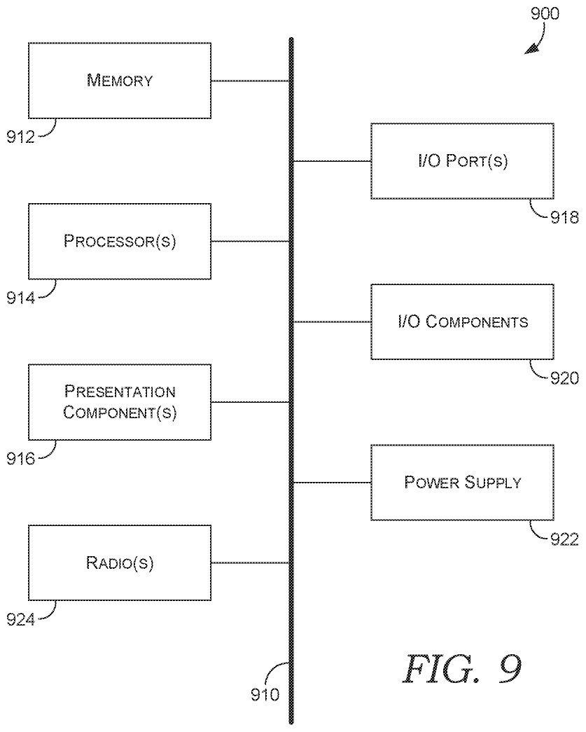

Turning to the figures, FIG. 1 depicts an example configuration of an operating environment in which some implementations of the present disclosure can be employed. It should be understood that this and other arrangements described herein are set forth only as examples. Other arrangements and elements (e.g., machines, interfaces, functions, orders, and groupings of functions, etc.) can be used in addition to or instead of those shown, and some elements can be omitted altogether for the sake of clarity. Further, many of the elements described herein are functional entities that can be implemented as discrete or distributed components or in conjunction with other components, and in any suitable combination and location. Various functions described herein as being performed by one or more entities can be carried out by hardware, firmware, and/or software. For instance, some functions can be carried out by a processor executing instructions stored in memory as further described with reference to FIG. 9.

It should be understood that operating environment 100 shown in FIG. 1 is an example of one suitable operating environment. Among other components not shown, operating environment 100 includes a user device 102, application 110, a customer device 112, application 120, network 104, and on-device journey management platform 108. Each of the components shown in FIG. 1 can be implemented via any type of computing device, such as one or more of computing device 900 described in connection to FIG. 9, for example.

These components can communicate with each other via network 104, which can be wired, wireless, or both. Network 104 can include multiple networks, or a network of networks, but is shown in simple form so as not to obscure aspects of the present disclosure. By way of example, network 104 can include one or more wide area networks (WANs), one or more local area networks (LANs), one or more public networks such as the Internet, one or more private networks, one or more cellular networks, one or more peer-to-peer (P2P) networks, one or more mobile networks, or a combination of networks. Where network 104 includes a wireless telecommunications network, components such as a base station, a communications tower, or even access points (as well as other components) can provide wireless connectivity. Networking environments are commonplace in offices, enterprise-wide computer networks, intranets, and the Internet. Accordingly, network 104 is not described in significant detail.

It should be understood that any number of user devices, servers, and other components can be employed within operating environment 100 within the scope of the present disclosure. Each can comprise a single device or multiple devices cooperating in a distributed environment.

User device 102 can be any type of computing device capable of being operated by an individual(s) (e.g., a marketer or business designing customer journeys via application 110). For example, in some implementations, such devices are the type of computing device described in relation to FIG. 9. By way of example and not limitation, user devices can be embodied as a personal computer (PC), a laptop computer, a mobile device, a smartphone, a tablet computer, a smart watch, a wearable computer, a personal digital assistant (PDA), an MP3 player, a global positioning system (GPS) or device, a video player, a handheld communications device, a gaming device or system, an entertainment system, a vehicle computer system, an embedded system controller, a remote control, an appliance, a consumer electronic device, a workstation, any combination of these delineated devices, or any other suitable device.

Customer device 112 can be any type of computing device capable of being operated by an individual(s) (e.g., a customer interacting with an application 120 for which a journey is executed). For example, in some implementations, such devices are the type of computing device described in relation to FIG. 9. By way of example and not limitation, user devices (e.g., customer devices) can be embodied as a personal computer (PC), a laptop computer, a mobile device, a smartphone, a tablet computer, a smart watch, a wearable computer, a personal digital assistant (PDA), an MP3 player, a global positioning system (GPS) or device, a video player, a handheld communications device, a gaming device or system, an entertainment system, a vehicle computer system, an embedded system controller, a remote control, an appliance, a consumer electronic device, a workstation, any combination of these delineated devices, or any other suitable device.

The user device 102 and/or customer device 112 can include one or more processors, and one or more computer-readable media. The computer-readable media may include computer-readable instructions executable by the one or more processors. The instructions may be embodied by one or more applications, such as application 110 and/or application 120 shown in FIG. 1. Application 110 and application 120 are each referred to as single applications for simplicity, but its functionality can each be embodied by one or more applications in practice.

Application 110 operating on user device 102 can generally be any application capable of facilitating the exchange of information between the user device 102 and the on-device journey management platform 108 in displaying and exchanging information regarding customer journeys, such as the design of customer journeys. In some implementations, the application 110 comprises a web application, which can run in a web browser, and could be hosted at least partially server-side (e.g., via on-device journey management platform 108). In addition, or instead, the application 110 can comprise a dedicated application. In some cases, the application 110 is integrated into the operating system (e.g., as a service). It is therefore contemplated herein that “application” be interpreted broadly. As specific example applications, application 110 may be a customer journey management website or application or any website or application that is capable of designing customer journeys. Such an application may be accessed via a mobile application, a web application, or the like.

User device 102 can be a client device on a client-side of operating environment 100, while on-device journey management platform 108 can be on a server-side of operating environment 100. On-device journey management platform 108 may comprise server-side software designed to work in conjunction with client-side software on user device 102 so as to implement any combination of the features and functionalities discussed in the present disclosure. An example of such client-side software is application 110 on user device 102. This division of operating environment 100 is provided to illustrate one example of a suitable environment, and it is noted there is no requirement for each implementation that any combination of user device 102 or on-device journey management platform 108 to remain as separate entities.

Application 120 operating on customer device 112 can generally be any application utilized by a business to interact with a customer (e.g., a customer utilizing customer device 112), such as the mobile application of the business. In some implementations, the application 120 comprises a web application, which can run in a web browser, and could be hosted at least partially server-side. In addition, or instead, the application 120 can comprise a dedicated application. In some cases, the application 120 is integrated into the operating system (e.g., as a service). It is therefore contemplated herein that “application” be interpreted broadly. As specific example applications, application 120 may be an e-commerce website or application or any type of website or application. Such an application may be accessed via a mobile application, a web application, or the like. Customer device 112 can be a client device on a client-side of operating environment 100, while features of application 120 are executed from a server-side of operating environment 100. On-device journey management platform 108 may comprise server-side software designed to work in conjunction with client-side software on customer device 112 so as to implement any combination of the features and functionalities discussed in the present disclosure.

In operation, as described herein, a journey is designed by a journey designer, such as a user implementing customer journeys on behalf of a business, via application 110 through a display of user device 102 in communication with on-device journey management platform 108. The journey can be designed through the on-device journey management platform 108 to utilize in-app interactions between a customer (e.g., a user utilizing an application of a business, such as a mobile application of the business) and application 120 executing on the customer device 112. For example, the application 120 may enable a push notification (e.g., an action of a journey) responsive to a customer adding an item to a cart and subsequently closing the application 120 (e.g., events of the journey). In this regard, the journey can be published to the customer device 112 by on-device journey management platform 108, thereby storing the journey directly on the customer device 112. By storing the journey directly on the customer device 112, the journey can be executed directly on the customer device 112 based on the in-app interactions between the customer and the application 120 without requiring communication of the various states of the journey over network 104 to on-device journey management platform 108.

In some embodiments, a SDK for on-device journey orchestration is stored on a customer's device in communication with and/or as a part of the application 120. The SDK can include various tools to communicate with on-device journey management platform 108 to receive journeys related to the application 120 or communicate the state of the journeys stored on the customer device 112, listen to in-app interactions between the customer and the application 120 on the customer device 112, and execute journeys on the customer device 112. In this regard, the SDK for on-device journey orchestration enables the execution of journeys on the customer device 112 after the journey is stored on the customer device 112 without having to communicate each state of the journey (e.g., the change to the journey as each event, condition, and/or action of the journey occurs) to on-device journey management platform 108 before proceeding to the next step of the journey. When the customer device 112 is connected to the network 104 and/or at certain intervals, the SDK can communicate the state of the journey or other customer data to the on-device journey management platform 108 and/or receive new journeys or updates to journeys for storage on the customer device 112.

In some embodiments, the on-device journey management platform 108 includes a remote device handler service that utilizes customer data to only implement the journeys on the customer device 112 that pertain to the specific customer utilizing customer device 112 and/or application 120. For example, if a journey is directed to a customer that purchased a specific product based on the purchase history in the customer data for the customer, remote devices handler service can determine whether the customer associated with customer device 112 and/or application 120 meets the requirements (e.g., whether the customer data indicates that the customer purchased the specific product) to store the journey on the customer device 112. If the customer meets the requirements to store the journey, remote devices handler service can store the journey on the customer device 112. In this regard, computing and network resources can be conserved in that only data for journeys related to the specific customer of customer device 112 are communicated and/or stored on the customer device 112.

At a high level, on-device journey management platform 108 performs various functionality to facilitate efficient and effective on-device journey implementation. The on-device journey management platform 108 can communicate with application 110 in order for application 110 to display a journey for design via a display screen of the user device 102. The on-device journey management platform 108 can communicate with application 110 in order to receive a selection to publish a journey. The on-device journey management platform 108 can communicate with customer device 112 and/or application 120 in order to store the journey on customer device 112 for use by application 120 to implement in-app actions with respect to the journey.

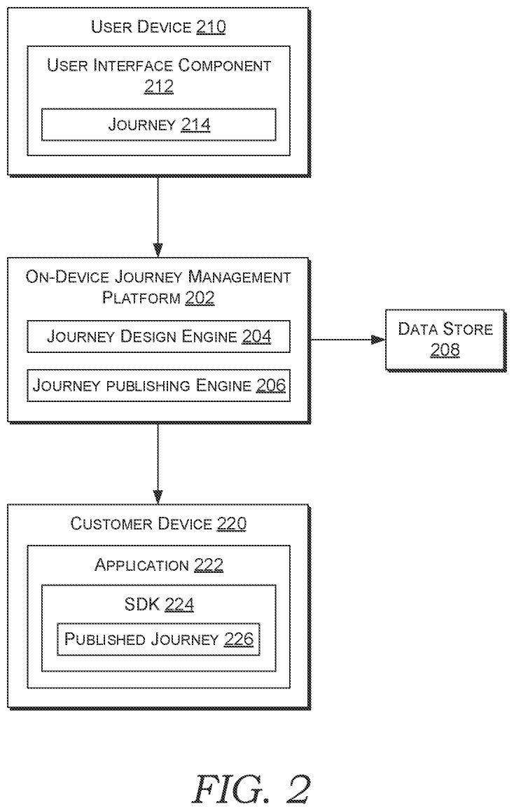

On-device journey management platform 108 can be or include a server, including one or more processors, and one or more computer-readable media. The computer-readable media includes computer-readable instructions executable by the one or more processors. The instructions can optionally implement one or more components of on-device journey management platform 108, described in additional detail below with respect to on-device journey management platform 202 of FIG. 2. For cloud-based implementations, the instructions on on-device journey management platform 108 can implement one or more components, and application 110 can be utilized by a user to interface with the functionality implemented on on-device journey management platform 108. In some cases, application 110 comprises a web browser. In other cases, on-device journey management platform 108 may not be required. For example, the components of on-device journey management platform 108 may be implemented completely on a user device, such as user device 102. In this case, on-device journey management platform 108 may be embodied at least partially by the instructions corresponding to application 110.

Thus, it should be appreciated that on-device journey management platform 108 may be provided via multiple devices arranged in a distributed environment that collectively provide the functionality described herein. Additionally, other components not shown may also be included within the distributed environment. In addition, or instead, on-device journey management platform 108 can be integrated, at least partially, into a user device, such as user device 102. Furthermore, on-device journey management platform 108 may at least partially be embodied as a cloud computing service.

Referring to FIG. 2, aspects of an illustrative on-device journey management system are shown, in accordance with various embodiments of the present disclosure. At a high level, the on-device journey management system facilitates the execution of a customer journey based on local (e.g., in-app) events or conditions of the device without having to communicate the events or conditions over a network.

As shown in FIG. 2, on-device journey management platform 202 includes a journey design engine 204 and a journey publishing engine 206. The on-device journey management platform 202 can communicate with the data store 208. The data store 208 is configured to store various types of information accessible by on-device journey management platform 202, or other server or component. The foregoing components of on-device journey management platform 202 can be implemented, for example, in operating environment 100 of FIG. 1. In particular, those components may be integrated into any suitable combination of user devices 102, customer devices 112, and/or on-device journey management platform 108.

In embodiments, data sources, user devices (such as user device 102 of FIG. 1 and customer device 112 of FIG. 1), and on-device journey management platform 202 can provide data to the data store 208 for storage, which may be retrieved or referenced by any such component. As such, the data store 208 can store computer instructions (e.g., software program instructions, routines, or services), data and/or models used in embodiments described herein, customer journeys with events, actions and/or conditions, customer data, and/or the like. In some implementations, data store 208 can store information or data received or generated via the various components of on-device journey management platform 202 and provides the various components with access to that information or data, as needed. The information in data store 208 may be distributed in any suitable manner across one or more data stores for storage (which may be hosted externally).

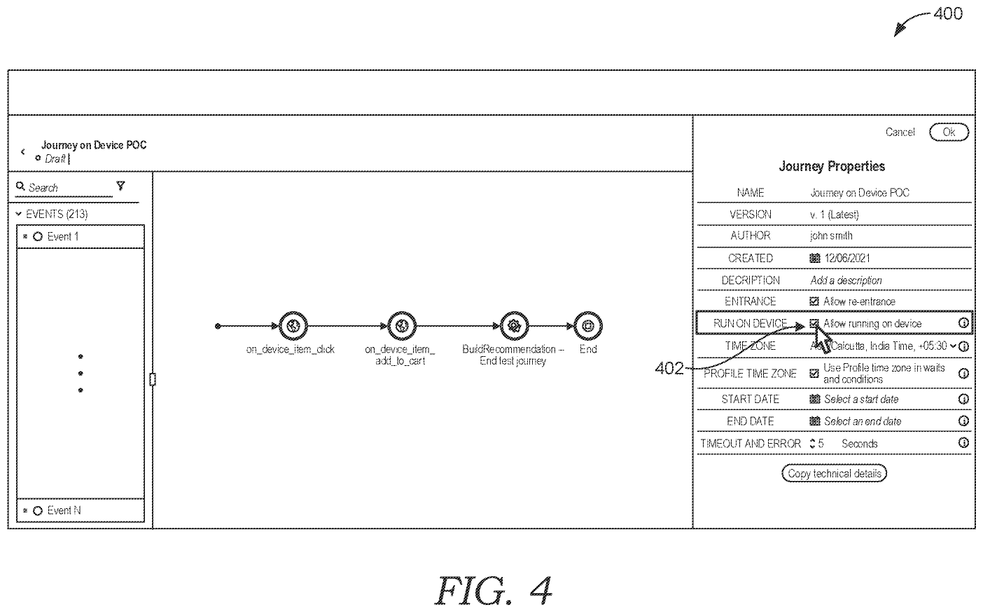

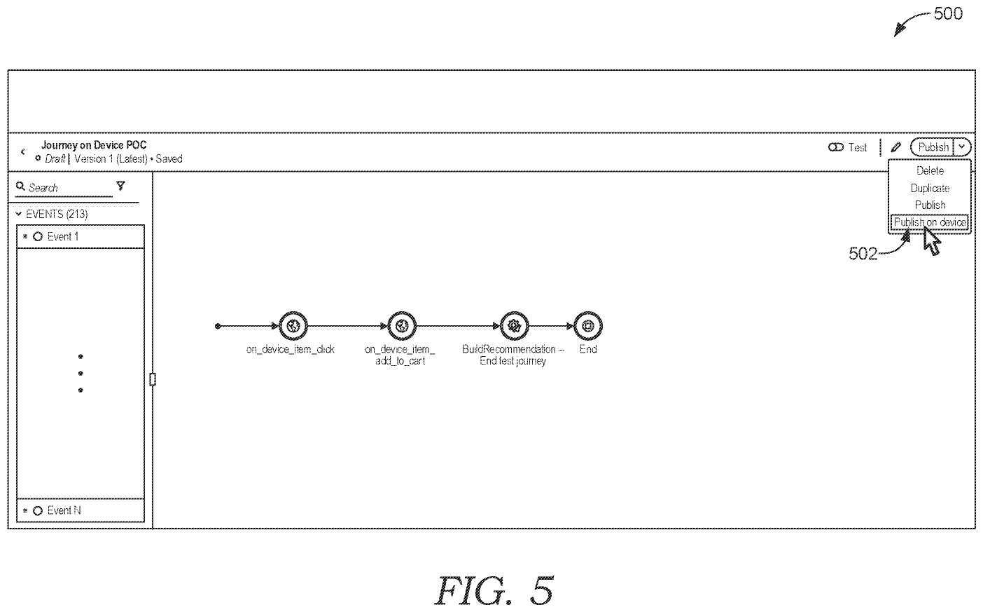

The journey design engine 204 is generally configured to enable a user to design a journey. In embodiments, journey design engine 204 can include rules, conditions, associations, models, algorithms, or the like to enable a user to design a journey. An example of a user interface of journey design engine 204 is shown in FIGS. 4 and 5. The journey publishing engine 206 is generally configured to publish a journey for storage on a customer device (e.g., customer device 220). In embodiments, journey publishing engine 206 can include rules, conditions, associations, models, algorithms, or the like to publish a journey for storage on a customer device (e.g., customer device 220).

In embodiments, journey 214 is designed by a user, such as a user implementing customer journeys on behalf of a business, via user interface component 212 through a display of user device 210 (e.g., user device 102 of FIG. 1) in communication with journey design engine 204 of on-device journey management platform 202. Journey publishing engine 206 publishes the journey 214 on the customer device 220 (e.g., customer device 112 of FIG. 1), thereby storing the journey directly on the customer device 220 as published journey 226. By storing the journey (e.g., published journey 226) directly on the customer device 220, the journey can be executed directly on the customer device 220 based on the in-app interactions between the customer and the application 222 without requiring communication of the various states of the journey over a network to on-device journey management platform 202.

In some embodiments, SDK 224 for on-device journey orchestration is stored on customer device 220 in communication and/or as a part of the application 222. The SDK 224 can include various tools to communicate with on-device journey management platform 202 to receive journeys related to the application 222 or communicate the state of journeys stored on the customer device 220, listen to in-app interactions between the customer and the application 222 on the customer device 220, and execute journeys on the customer device 220. In this regard, the SDK 224 for on-device journey orchestration enables the execution of journeys on the customer device 220 after the journey is stored on the customer device 220 without having to communicate each state of the journey (e.g., the change to the journey as each event, condition, and/or action of the journey occurs) to the on-device journey management platform 202 before proceeding to the next step of the journey. When the customer device 220 is connected to the network and/or at certain intervals, the SDK 224 can communicate the state of the journey or other customer data to the on-device journey management platform 202 for storage in data store 208 and/or receive new journeys or updates to journeys for storage on the customer device 220.

In some embodiments, journey publishing engine 206 includes a remote device handler service that utilizes customer data (e.g., as stored in data store 208) to only implement the journeys on the customer device 220 that pertain to that specific customer utilizing the customer device 220 and/or application 222. In this regard, computing and network resources can be conserved in that only data for journeys related to the specific customer of the customer device 220 are communicated and/or stored on the customer device 220.

In some embodiments, on-device journey management platform 202 and/or SDK 224 may utilize natural language processing techniques, a statistical model, fuzzy logic, neural network, finite state machine, support vector machine, logistic regression, clustering, or machine-learning techniques, similar statistical classification processes, or combinations of these to generate custom actions for on-device journey orchestration. For example, for an action of a journey to generate product recommendations in application 222 based on customer's interactions with application 222 on customer device 220, machine learning techniques can be utilized to generate specific product recommendations through application 222 without having to connect to a server to retrieve the product recommendations.

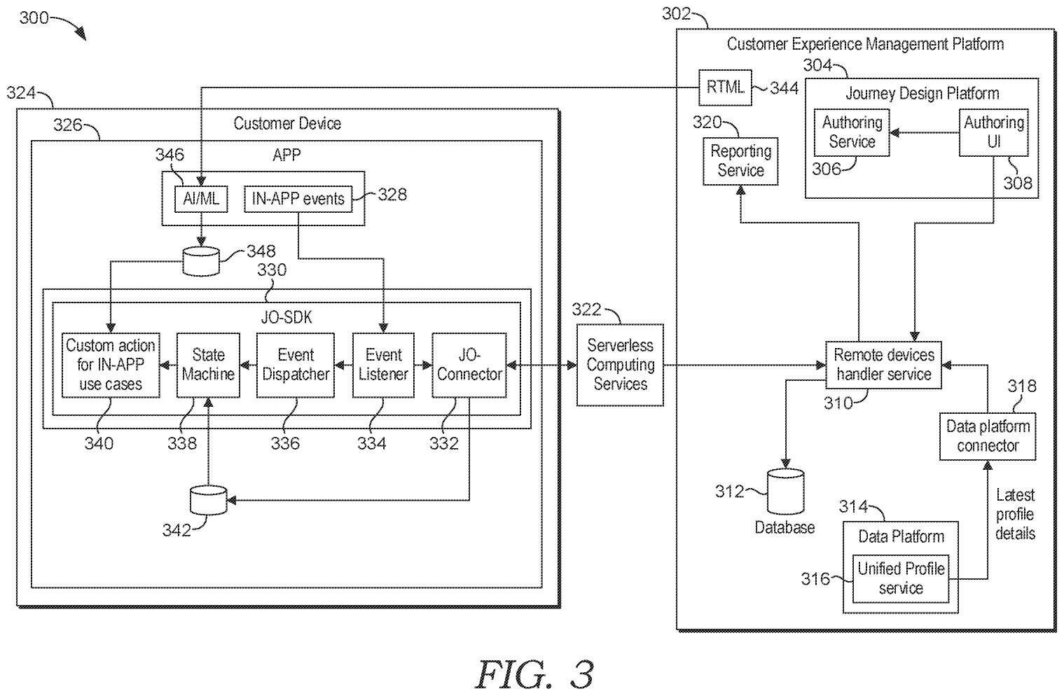

FIG. 3 provides an example diagram of an architecture for implementing on-device journey execution, in accordance with embodiments of the present disclosure. As shown in diagram 300, customer experience management platform 302 includes a journey design platform 304 that enables users to design journeys for customers. Journey design platform 304 includes authoring user interface (“UI”) 306 and authoring service 308. Authoring UI provides a UI that enables users to design journeys. Examples of authoring UI 306 are provided in FIGS. 4 and 5. Authoring UI 306 communicates through authoring service 308 to provide journey version updates based on edits by the user to the journey through authoring UI 306.

The journeys and/or journey version updates for existing journey flows and device integrations flows are communicated from journey design platform 304 to remote devices handler service 310. In this regard, all journeys and/or updates to journeys are communicated through remote devices handler service 310. For example, when a user of customer experience management platform 302 publishes a journey or makes updates to a published journey, the journey is published on a customer's device (e.g., customer device 324) through remote devices handler service 310 via serverless computing services 322. As another example, as a journey is executed on device, such as through certain events, conditions and/or actions occurring on a customer device 324, the updates of the state of the journey are communicated to the customer experience management platform 302 through remote devices handler service 310 (e.g., when the device connects back to the network or at certain intervals) via serverless computing services 322. The journeys and/or updates to journeys are stored in database 312.

Customer experience management platform 302 includes data platform 314 that communicates customer data stored in unified profile service 316. Unified profile service 316 stores customer data, such as customer profiles for use by customer experience management platform 302. The customer data stored in unified profile service 316 is communicated through data platform connector 318 to remote devices handler service 310. In this regard, remote devices handler service 310 can utilize the customer data stored in unified profile service 316 to determine whether a journey should be published on a customer's device. For example, if a journey is directed to a customer that purchases of a specific product or if a journey is directed to a customer that is above a certain age, remote devices handler service 310 can determine whether the customer associated with customer device 324 meets the requirements of the journey. If the customer meets the requirements of the journey, remote devices handler service 310 can publish the journey on the customer's device 324 through serverless computing services 322. In this regard, computing and network resources can be conserved in that only data for journeys related to the specific customer of the customer device (e.g., customer device 324) is communicated by customer experience management platform 302 and stored on customer device 324.

Customer experience management platform 302 includes reporting service 320. The states of the various customer journeys are communicated to the user of the customer experience management platform 302 through reporting service 320. Reporting service 320 provides reports of customer journeys. For example, reporting service 320 can provide data indicating the state of a customer on a specific customer journey. As another example, reporting service 320 can indicate how many customers followed each path of a journey, such as how many customers reached a certain event or action within a specific journey or any number of journeys.

Customer device 324 includes an application 326 (e.g., application 120 of FIG. 1 and/or application 222 of FIG. 2). Application 326 allows a customer (e.g., operating customer device 324) to interact with a business providing the application 326. In this regard, as the customer interacts with application 326, the customer triggers in-app events 328. For example, in-app events 328 can include when the customer opens or closes the application 326, the user selects an item, such as a product, in the application 326, the user adds an item to a shopping a cart in application 326, or any interaction by the customer with the application 326.

Journey orchestration SDK (“JO-SDK”) 330 is installed on the customer device 324 in communication with and/or as a part of application 326. In some embodiments, JO-SDK can be installed on the customer device as an add-on to application 326, Serverless computing services 322 provides access and communication between the JO-SDK 330 (e.g., through Journey orchestration connector (“JO-connector”)) of application 326 of the customer device 324 and customer experience management platform 302. JO-SDK 330 includes JO-connector 332. JO-connector 332 communicates changes to a journey(s) from in-app events 328 as the customer interacts with application 326 of customer device 324 (e.g., transitions/changes to the state of the journey stored on the customer device 324) to remote device handler service 310 via serverless computing services 322 (e.g., when the device connects back to the network or at certain intervals) based on interactions between the customer and the application 326 and/or the customer device 324. Further, JO-connector 332 communicates profile details of the customer to remote device handler service 310 via serverless computing services 322 (e.g., when the device connects back to the network or at certain intervals) based on interactions between the customer and the application 326 and/or the customer device 324.

JO-SDK 330 includes event listener 334 and event dispatcher 336. Event listener 334 monitors in-app events 328 (e.g., customers interactions with application 326 through customer device 324) and event dispatcher 336 determines whether a journey(s) stored on the customer device 324 (e.g., state transition mapping details 342) utilize a monitored event to move the journey(s) to the next state (e.g., meets an event, condition, and/or action of the journey).

JO-SDK 330 includes state machine 338. State machine 338 persists a customer's state in a journey stored on the customer device 324 (e.g., state transition mapping details 342) and utilizes an event from event dispatcher 336 to update the customer's state in the journey by updating the journey in state transition mapping details 342. For example, if an event in a journey requires a user to select an item and event dispatcher 336 identifies an event occurring where the customer selects the item in application 326 (e.g., from the customer interactions of in-app events 328), state machine 338 updates the customer's state in the journey as stored in state transition mapping details 342.

When an action (e.g., custom action for in-app use cases 340) is reached by a customer's state in a journey (e.g., as persisted by state machine 338), the action is executed directly by the application 326 on the customer device 324 without having to communicate the journey to an external server (e.g., customer experience management platform 302). For example, the action in the journey may call to specific in-app actions (e.g., custom action for in-app use cases 340), such as sending a push notification of an offer from application 326, updating a recommendation list in application 326, updating view of a UI of application 326, or any in-app action. In this regard, actions of journeys can still be executed for customers that are offline that are still utilizing an application 326. For example for in-app shopping, actions from journeys can be implemented to provide product recommendations, offers, cart abandonment, and/or push notifications directly on the customer device while the customer is still offline.

In this regard, computing and network resources can be conserved in that only data for journeys related to the specific customer of the customer device (e.g., customer device 324) is stored on customer device 324 in order to reduce the amount of data stored via state machine 338 and/or state transition mapping details 342 on a customer device 324 and/or communicated to and/or from customer device 324. Further, the journeys are executed in real-time as the journeys do not need to be communicated over a server for execution.

Further, in some embodiments, state machine 338 only persists the state of journeys orchestrated on a customer's device corresponding to journeys that only include in-app events, in-app conditions and/or in-app actions and do not include events, conditions and/or actions that must be communicated over a server. Rather, in some embodiments, customer experience management platform 302 includes a separate state machine that persists the state of journeys for journeys that include events, conditions and/or actions that must be communicated over a server. In this regard, computing and network resources can be conserved as the size of state machine 338 stored on the customer device 220 is reduced.

In some embodiments, the action in the journey may call to a specific in-app action (e.g., custom action for in-app use cases 340) directly from the application 326 executing on customer device 324. In some embodiments, the action in the journey may call to a specific in-app action (e.g., custom action for in-app use cases 340) from a server that is in communication with the application 326 without communicating with a server executing the journey.

In some embodiments, real-time machine learning (“RTML”) 344 is utilized by application 326 in order to use artificial intelligence/machine learning (“AI/ML”) algorithms 346 to generate algorithms for custom action processing and store the AI/ML actions in storage 348. In this regard, custom action configurations can be automatically generated for specific customer use cases using machine learning techniques. For example, product recommendations can be generated on the device using machine learning techniques without having to connect to a server to retrieve the product recommendations.

FIGS. 4 and 5 provide example diagrams of a user interface with an example journey for implementing on-device journey execution, in accordance with embodiments of the present disclosure. As shown in FIGS. 4 and 5, a user, such as a business/marketer can design a customer journey in a user interface (“UI”) shown in diagram 400 of FIG. 4 and diagram 500 of FIG. 5. As can be appreciated from the example shown in FIGS. 4 and 5, the journey includes any number of events, conditions, and/or actions. For example, the events can be selected from a dropdown list of events (e.g., labeled as event 1 through event n). In the example shown in FIGS. 4 and 5, the journey includes the events labeled on_device_item_click (e.g., the customer clicks an item through an application executing on the customer's device) and on_device_item_add_to_cart (e.g., the customer adds an item to the customer's cart through the application executing on the customer's device). In this regard, the events shown in FIGS. 4 and 5 are events which occur within the application (e.g., “in-app events”). Further, in the example shown in FIGS. 4 and 5, the journey includes the action labeled BuildRecommendation (e.g., a recommended item(s) is identified and displayed in the application executing on the customer's device based on the item clicked and/or added to the customer's cart).

As shown in FIG. 4, the user (e.g., the person designing the customer journey) can select option 402 to run on device in order to enable the execution of the journey on the device of the customer without requiring communication of the events, conditions, and/or actions with a server executing the journeys. As shown in FIG. 5, the user (e.g., the person designing the customer journey) can select option 502 to publish the journey on the customer's device. In this regard, the journey is stored on the customer's device to enable on-device and/or offline journey execution. For example, when the customer clicks an item and adds an item to a cart through an application executing on the customer's device, a recommended item(s) can be identified and displayed in the application executing on the customer's device based on the item clicked and/or added to the customer's cart without requiring communication of the journey to a server. The example journey shown in FIGS. 4 and 5 can be simulated using the example architecture of FIGS. 1-3.

### Exemplary Implementations of On-Device Journey Execution

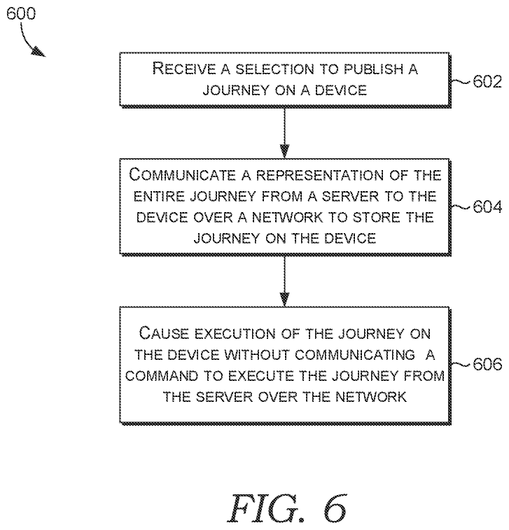

With reference now to FIGS. 6-8, flow diagrams are provided showing exemplary methods 600-800 related to on-device journey execution, in accordance with embodiments of the present technology. Each block of methods 600-800 comprises a computing process that can be performed using any combination of hardware, firmware, and/or software. For instance, various functions can be carried out by a processor executing instructions stored in memory. The methods can also be embodied as computer-usable instructions stored on computer storage media. The methods can be provided by a standalone application, a service or hosted service (standalone or in combination with another hosted service), or a plug-in to another product, to name a few. The method flows of FIGS. 6-8 are exemplary only and not intended to be limiting. As can be appreciated, in some embodiments, method flows 600-800 can be implemented, at least in part, to facilitate on-device journey execution.

Turning initially to FIG. 6, a flow diagram is provided showing an embodiment of a method 600 for on-device journey execution in accordance with embodiments described herein. Such on-device journey execution can be used to efficiently and effectively facilitate the execution of an action of a customer journey based on local (e.g., in-app) events or conditions of the device without having to communicate the events or conditions over a network. Initially, at block 602, a selection to publish a journey on a device is received. In embodiments, the selection to publish a journey is provided by an on-device journey management platform (e.g., on-device journey management platform 108 of FIG. 1, on-device journey management platform 202 of FIG. 2 or customer experience management platform 302 with journey design platform 304 of FIG. 3). At block 604, a representation of the journey is communicated from a server to a device over a network to store the journey on the device. In some embodiments, the journey includes a sequence of events, conditions, and/or conditions and may be in the form of a set of JSONs representing each of the events, conditions, and/or conditions of the journey. In some embodiments, all nodes of the journey (e.g., all events, conditions, and/or actions of the journey) that are stored on the device are capable of being executed on the device without requiring communicating a command to execute the node of the journey via a server over the network. At block 606, the journey is executed on the device using the journey stored locally on the device without communicating a command to execute the journey from the server over the network. In some embodiments, at least a portion of the journey is executed on the device using the journey stored locally on the device without communicating a command to execute the at least the portion of the journey from the server over the network. In some embodiments, the portion of the journey corresponds to an action of the journey executed by the application on the device. In some embodiments, the portion of the journey is executed on the device based on a condition of the journey and/or an event of the journey.

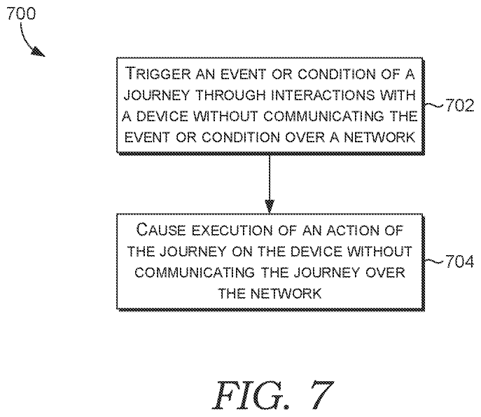

Turning now to FIG. 7, a flow diagram is provided showing an embodiment of a method 700 for on-device journey execution in accordance with embodiments described herein. Such on-device journey execution can be used to efficiently and effectively facilitate the execution of an action of a customer journey based on local (e.g., in-app) events or conditions of the device without having to communicate the events or conditions over a network. Initially, at block 702, an event or condition of a journey is triggered through interactions with a device without communicating the event or condition over a network. In some embodiments, interactions between the user (e.g., customer) and the application executing on the device are monitored by an SDK (e.g. SDK 224 of FIG. 2 or JO-SDK 330 via event listener 334 of FIG. 3) in communication with the application. At block 704, an action of the journey is executed on the device without communicating the journey over the network. In some embodiments, a state machine is stored on the device in communication with the application and the state machine persists a state of the journey on the device.

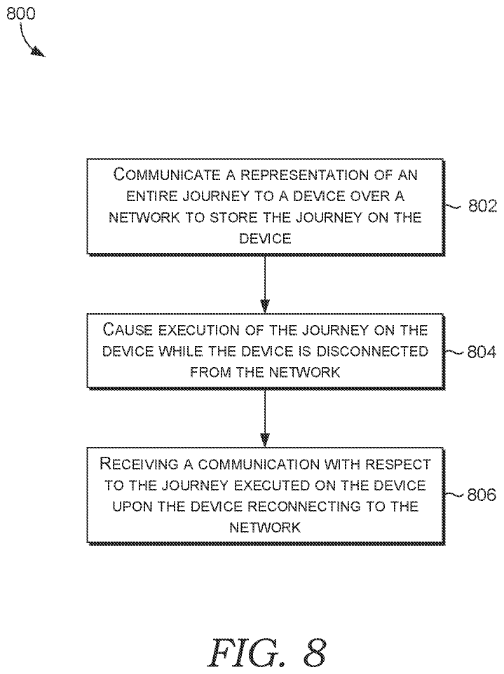

Turning now to FIG. 8, a flow diagram is provided showing an embodiment of a method 800 for on-device journey execution in accordance with embodiments described herein. Such on-device journey execution can be used to efficiently and effectively facilitate the execution of an action of a customer journey based on local (e.g., in-app) events or conditions of the device without having to communicate the events or conditions over a network. Initially, at block 802, a representation of a journey is communicated to a device over a network to store the journey on the device. In some embodiments, a user (e.g., customer) is identified based on the device and only a journey corresponding to the user of the device is communicated to the device. In some embodiments, before communicating the representation of the journey to a device over a network to store the journey on the device, all nodes of the journey (e.g., all events, conditions, and/or actions of the journey) are confirmed by the application to be capable of being executed on the device without requiring communicating a command to execute the node of the journey via a server over the network.

At block 804, the journey is executed on the device while the device is disconnected from the network. In some embodiments, at least a portion of the journey is executed on the device while the device is disconnected from the network. For example, after the representation of the journey is communicated to the device over the network and stored on the device, a user (e.g., customer) boards an airplane and the device become disconnected from the network. While disconnected from the network, the user triggers an event or condition of the journey, thereby causing a state machine stored on the device to transition to a different state in the journey. In some embodiments, the portion of the journey executed on the device corresponds to an action of the journey that is performed while the device is disconnected from the network.

At block 806, a communication is received with respect to the journey executed on the device upon the device reconnecting to the network. In some embodiments, a communication is received with respect to the portion of the journey executed on the device upon the device reconnecting to the network. For example, after the journey and/or portion of the journey is executed on the device while the device is disconnected from the network, the user reconnects their device to the internet after the plane lands. An SDK stored on the device communicates data related to the journey, such as the current state of the journey, events, conditions and/or actions of the journey triggered, and any other customer data to an on-device journey management platform (e.g., on-device journey management platform 108 of FIG. 1, on-device journey management platform 202 of FIG. 2 or customer experience management platform 302 with journey design platform 304 of FIG. 3) over the network. In this regard, the on-device journey management platform can store the data related to the journey, update the state of the journey through a state machine of the on-device journey management platform, and communicate any data with respect to the journey, changes to the journey, or new journeys to the device through the SDK stored on the device.

### Overview of Exemplary Operating Environment

Having briefly described an overview of aspects of the technology described herein, an exemplary operating environment in which aspects of the technology described herein may be implemented is described below in order to provide a general context for various aspects of the technology described herein.

Referring to the drawings in general, and initially to FIG. 9 in particular, an exemplary operating environment for implementing aspects of the technology described herein is shown and designated generally as computing device 900. Computing device 900 is just one example of a suitable computing environment and is not intended to suggest any limitation as to the scope of use or functionality of the technology described herein. Neither should the computing device 900 be interpreted as having any dependency or requirement relating to any one or combination of components illustrated.

The technology described herein may be described in the general context of computer code or machine-usable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Aspects of the technology described herein may be practiced in a variety of system configurations, including handheld devices, consumer electronics, general-purpose computers, and specialty computing devices. Aspects of the technology described herein may also be practiced in distributed computing environments where tasks are performed by remote-processing devices that are linked through a communications network.

With continued reference to FIG. 9, computing device 900 includes a bus 910 that directly or indirectly couples the following devices: memory 912, one or more processors 914, one or more presentation components 916, input/output (I/O) ports 918, I/O components 920, an illustrative power supply 922, and a radio(s) 924. Bus 910 represents what may be one or more busses (such as an address bus, data bus, or combination thereof). Although the various blocks of FIG. 9 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors hereof recognize that such is the nature of the art, and reiterate that the diagram of FIG. 9 is merely illustrative of an exemplary computing device that can be used in connection with one or more aspects of the technology described herein. Distinction is not made between such categories as “workstation,” “server,” “laptop,” and “handheld device,” as all are contemplated within the scope of FIG. 9 and refer to “computer” or “computing device.”

Computing device 900 typically includes a variety of computer-readable media. Computer-readable media can be any available media that can be accessed by computing device 900 and includes both volatile and nonvolatile, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program sub-modules, or other data.

Computer storage media includes RAM, ROM, EEPROM, flash memory or other memory technology, CD-ROM, digital versatile disks (DVD) or other optical disk storage, magnetic cassettes, magnetic tape, magnetic disk storage, or other magnetic storage devices. Computer storage media does not comprise a propagated data signal.

Communication media typically embodies computer-readable instructions, data structures, program sub-modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media.

Memory 912 includes computer storage media in the form of volatile and/or nonvolatile memory. The memory 912 may be removable, non-removable, or a combination thereof. Exemplary memory includes solid-state memory, hard drives, and optical-disc drives. Computing device 900 includes one or more processors 914 that read data from various entities such as bus 910, memory 912, or I/O components 920. Presentation component(s) 916 present data indications to a user or other device. Exemplary presentation components 916 include a display device, speaker, printing component, and vibrating component. I/O port(s) 918 allow computing device 900 to be logically coupled to other devices including I/O components 920, some of which may be built in.

Illustrative I/O components include a microphone, joystick, game pad, satellite dish, scanner, printer, display device, wireless device, a controller (such as a keyboard, and a mouse), a natural user interface (NUI) (such as touch interaction, pen (or stylus) gesture, and gaze detection), and the like. In aspects, a pen digitizer (not shown) and accompanying input instrument (also not shown but which may include, by way of example only, a pen or a stylus) are provided in order to digitally capture freehand user input. The connection between the pen digitizer and processor(s) 914 may be direct or via a coupling utilizing a serial port, parallel port, and/or other interface and/or system bus known in the art. Furthermore, the digitizer input component may be a component separated from an output component such as a display device, or in some aspects, the usable input area of a digitizer may be coextensive with the display area of a display device, integrated with the display device, or may exist as a separate device overlaying or otherwise appended to a display device. Any and all such variations, and any combination thereof, are contemplated to be within the scope of aspects of the technology described herein.

A NUI processes air gestures, voice, or other physiological inputs generated by a user. Appropriate NUI inputs may be interpreted as ink strokes for presentation in association with the computing device 900. These requests may be transmitted to the appropriate network element for further processing. A NUI implements any combination of speech recognition, touch and stylus recognition, facial recognition, biometric recognition, gesture recognition both on screen and adjacent to the screen, air gestures, head and eye tracking, and touch recognition associated with displays on the computing device 900. The computing device 900 may be equipped with depth cameras, such as stereoscopic camera systems, infrared camera systems, RGB camera systems, and combinations of these, for gesture detection and recognition. Additionally, the computing device 900 may be equipped with accelerometers or gyroscopes that enable detection of motion. The output of the accelerometers or gyroscopes may be provided to the display of the computing device 900 to render immersive augmented reality or virtual reality.

A computing device may include radio(s) 924. The radio 924 transmits and receives radio communications. The computing device may be a wireless terminal adapted to receive communications and media over various wireless networks. Computing device 900 may communicate via wireless protocols, such as code division multiple access (“CDMA”), global system for mobiles (“GSM”), or time division multiple access (“TDMA”), as well as others, to communicate with other devices. The radio communications may be a short-range connection, a long-range connection, or a combination of both a short-range and a long-range wireless telecommunications connection. When we refer to “short” and “long” types of connections, we do not mean to refer to the spatial relation between two devices. Instead, we are generally referring to short range and long range as different categories, or types, of connections (i.e., a primary connection and a secondary connection). A short-range connection may include a Wi-Fi® connection to a device (e.g., mobile hotspot) that provides access to a wireless communications network, such as a WLAN connection using the 802.11 protocol. A Bluetooth connection to another computing device is a second example of a short-range connection. A long-range connection may include a connection using one or more of CDMA, GPRS, GSM, TDMA, and 802.16 protocols.

The technology described herein has been described in relation to particular aspects, which are intended in all respects to be illustrative rather than restrictive. The technology described herein is described with specificity to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and “block” may be used herein to connote different elements of methods employed, the terms should not be interpreted as implying any particular order among or between various steps herein disclosed unless and except when the order of individual steps is explicitly described.

1. A computing system comprising:
a processor; and
a non-transitory computer-readable medium having stored thereon instructions that when executed by the processor, cause the processor to perform operations including:
receiving, via a journey design engine, a selection to publish a journey on a device;
communicating, via a journey publishing engine, a representation of the journey from a server to the device over a network to store the journey locally on the device; and
causing execution, via an application executing on the device, of at least a portion of the journey on the device using the journey stored locally on the device.

2. The system of claim 1, wherein the instructions that when executed by the processor, cause the processor to perform operations further including:
identifying a user based on the device; and
only communicating the representation of the journey upon determining that the journey corresponds to the user.

3. The system of claim 1, wherein the instructions that when executed by the processor, cause the processor to perform operations further including:
subsequent to causing execution of the at least the portion of the journey on the device, communicating the at least the portion of the journey to the server over the network.

4. The system of claim 1, wherein the instructions that when executed by the processor, cause the processor to perform operations further including:
causing monitoring of an event by the device, the event corresponding to an interaction between a user and the application executing on the device; and
causing execution of the at least the portion of the journey on the device based on the event.

5. The system of claim 1, wherein the instructions that when executed by the processor, cause the processor to perform operations further including:
causing execution of the at least the portion of the journey on the device based on a condition of the journey.

6. The system of claim 1, wherein the instructions that when executed by the processor, cause the processor to perform operations further including:
storing a state machine on the device, the state machine persisting a state of the journey on the device.

7. The system of claim 1, wherein the instructions that when executed by the processor, cause the processor to perform operations further including:
causing execution, via the application executing on the device, of the at least the portion of the journey on the device without communicating a command to execute the at least the portion of the journey from the server over the network, wherein the at least the portion of the journey corresponds to an action of the journey executed by the application on the device.

8. A non-transitory computer-readable medium storing executable instructions, which when executed by a processing device, cause the processing device to perform operations comprising:
triggering an event of a journey, via a software development kit (“SDK”) stored on a device in communication with an application stored on the device, based on interactions with the application on the device; and
prior to communicating the event of the journey to a server over a network, causing execution of an action of the journey on the device via the SDK.

9. The media of claim 8, the instructions, which when executed by the processing device, cause the processing device to perform the operations further comprising:
receiving, via a journey design engine, a selection to publish the journey on the device; and
communicating, via a journey publishing engine, a representation of the journey from the server to the device over the network to store the journey on the device.

10. The media of claim 9, the instructions, which when executed by the processing device, cause the processing device to perform the operations further comprising:
identifying a user based on the device; and
only communicating the representation of the journey upon determining that the journey corresponds to the user.

11. The media of claim 8, the instructions, which when executed by the processing device, cause the processing device to perform the operations further comprising:
subsequent to causing execution of the action of the journey on the device via the SDK, communicating a state of the journey to the server over the network.

12. The media of claim 8, the instructions, which when executed by the processing device, cause the processing device to perform the operations further comprising:
monitoring, via the SDK, a plurality of interactions between the user and the application executing on the device; and
triggering the event of the journey based on at least one of the plurality of interactions.

13. The media of claim 8, the instructions, which when executed by the processing device, cause the processing device to perform the operations further comprising:
storing a state machine on the device, the state machine persisting a state of the journey on the device.

14. The media of claim 8, wherein the event is triggered further based on a condition of the journey stored on the device.

15. A computer-implemented method comprising:
communicating, via a journey publishing engine, a representation of a journey to a device over a network to store the journey on the device; and
receiving, via a journey management platform, a communication comprising at least a portion of the journey previously executed on the device, wherein the at least the portion of the journey previously executed on the device was executed while the device was disconnected from the network and communicated by the device after the device reconnected to the network.

16. The computer-implemented method of claim 15, wherein the instructions that when executed by the processor, cause the processor to perform operations further including:
identifying a user based on the device; and
only communicating the representation of the journey upon determining that the journey corresponds to the user.

17. The computer-implemented method of claim 15, wherein the instructions that when executed by the processor, cause the processor to perform operations further including:
causing monitoring of an event by the device, the event corresponding to an interaction between a user and the application executing on the device; and
causing execution of the at least the portion of the journey on the device based on the event.

18. The computer-implemented method of claim 15, wherein the instructions that when executed by the processor, cause the processor to perform operations further including:
causing execution of the at least the portion of the journey on the device based on a condition of the journey.

19. The computer-implemented method of claim 15, wherein the instructions that when executed by the processor, cause the processor to perform operations further including:
storing a state machine on the device, the state machine persisting a state of the journey on the device.

20. The computer-implemented method of claim 15, wherein the at least the portion of the journey corresponds to an action of the journey executed by the application on the device.
